(19) United States
(12) Patent Application Publication
(10) Pub. No.: US 2018/0001696 A1
(43) Pub. Date: Jan. 4, 2018

(54) Component with Surface Structure Generated by Embossing and Method for the Production Thereof

(71) Applicant: Fritz EGGER GmbH & Co. OG, St. Johann in Tirol (AT)

(72) Inventor: Andreas Greyer, Krems (AT)

(73) Assignee: Fritz EGGER GmbH & Co. OG, St. Johann in Tirol (AT)

(21) Appl. No.: 15/543,086

(22) PCT Filed: Jan. 13, 2016
(86) PCT No.: PCT/EP2016/050542

§ 371 Date: Jul. 12, 2017

(30) Foreign Application Priority Data
Jan. 16, 2015 (DE) 10 2015 100 639.1

(51) Int. Cl. B44C 5/04; B44B 5/02; B32B 3/30; B32B 27/42; B32B 33/00; B32B 38/06; B32B 38/14; B44C 1/24; B32B 25/08; B29C 59/02

(52) U.S. Cl. CPC B44C 5/0461; B44C 1/24; B44B 5/026; B32B 3/30; B32B 25/08; B32B 27/42; B32B 33/00; B32B 38/06; B32B 38/14; B32B 2307/732; B32B 2307/554; B32B 2270/00; B32B 2307/754; B29C 2059/023; B32B 2419/04; B32B 2451/00; B32B 2479/00; B32B 2607/00; B32B 2317/12

(57) ABSTRACT

The invention relates to a component having a plate-shaped or profile-shaped support and a decorative surface layer connected to the support, the surface layer being formed of thermally curable resin and comprising a three-dimensional surface structure that is produced by embossing and is irregular. According to the invention, in order to inexpensively obtain a decorative surface which has good wear resistance and largely prevents disturbing finger prints, the surface structure comprises regions that are alternately ordered and non-ordered and that are formed by a ribbed and/or grooved structure, ordered regions having parallel and/or quasi-parallel ribs and/or parallel and/or quasi-parallel grooves being interrupted by non-ordered regions or structural breaks, and the width of the respective rib or groove being in the range of from 0.5 μm to 100 μm. Furthermore, a method for manufacturing a component of this type using a corresponding embossing tool is disclosed and claimed.

The invention relates to a component having a plate-shaped or profile-shaped support and a decorative surface layer connected to the support, the surface layer being formed of thermally curable resin and comprising a three-dimensional surface structure that is produced by embossing and is irregular. In addition, the invention relates to a method for manufacturing a component in which a plate-shaped or profile-shaped support is coated with a decorative surface layer, the surface layer is formed of a thermally curable resin and a three-dimensional, irregular surface structure is embossed into the surface layer.

Such components are known and are further processed, inter alia, into furniture elements, worktops, wall panels and the like.

In particular for furniture, it is perceived to be objectionable when the surfaces thereof have visible fingerprints. It is known that even clean hands can leave fingerprints since fingerprints are usually caused by hand sweat.

With respect to wood material boards, DE 10 2008 034 825 A1 suggests a finish for painted surfaces which reduces the tendency of painted surfaces to become soiled and at the same time is intended to achieve an anti-fingerprint effect. For this purpose, silanes are added to the finishing paints before said finishing paints are applied to the surfaces of the objects to be painted. Owing to the addition of silane, the wettability of the cured painted surface is significantly reduced and thus the tendency to become soiled is considerably reduced.

WO 02/064382 A2 describes coating compositions for floor or furniture laminates which are intended to give the coating thereof anti-soiling properties. For this purpose, it is suggested that the top protective layer of the laminate, which contains thermally curable resin, is coated with material made of substituted polysiloxane, or that such a material is mixed into the top protective layer of the laminate.

EP 1 475 426 A1 further describes a method for manufacturing separable dirt- and water-repellent flat coatings on objects, in which, for the coating, hydrophobic particles are applied to the surface of the objects and thus a surface structure having elevations is produced on the surface of the objects, which surface has dirt- and water-repellent properties. The method is characterised in that the hydrophobic particles are suspended in a solution of a silicone wax in a highly volatile siloxane, this suspension is applied to at least one surface of the object in question and finally the highly volatile siloxane is removed.

A drawback of the above-mentioned methods from the prior art is the significant cost of materials caused by the addition of silanes, substituted polysiloxane, or hydrophobic particles together with silicone wax and highly volatile siloxane. In addition, these additive materials are environmentally harmful and may be dangerous in terms of health.

Proceeding therefrom, the problem addressed by the present invention is that of cost-effectively providing components having a decorative surface, of which the decorative surface has a good wear resistance and largely prevents objectionable fingerprints. In addition, a method for cost-effectively manufacturing such components is also intended to be provided.

This problem is solved by a component or laminate having the features given in claim 1 or by a method having the features given in claim 7. Advantageous embodiments of the components according to the invention or the method according to the invention are given in the dependent claims.

The component or laminate according to the invention is constructed from a plate-shaped or profile-shaped support and a decorative surface layer connected to the support, the surface layer being formed of a thermally curable resin and comprising a three-dimensional surface structure which is produced by embossing and is irregular. According to the invention, the surface structure comprises regions that are alternately ordered and non-ordered and that are formed by a ribbed and/or grooved structure, ordered regions having parallel and/or quasi-parallel ribs and/or parallel and/or quasi-parallel grooves being interrupted by non-ordered regions or structural breaks, and the width of the respective rib or groove being in the range of from 0.5 μm to 100 μm, preferably in the range of from 2 μm to 50 μm.

The method according to the invention is correspondingly characterised in that an embossing tool is used to emboss the surface layer of the component formed of thermally curable resin, of which embossing tool the embossing surface comprises regions that are alternately ordered and non-ordered, which regions are formed by a ribbed and/or grooved structure, ordered regions having parallel and/or quasi-parallel ribs and/or parallel and/or quasi-parallel grooves being interrupted by non-ordered regions or structural breaks, and the width of the respective rib or groove being in the range of from 0.5 μm to 100 μm, preferably in the range of from 2 μm to 50 μm.

In this case, the mutually parallel and/or quasi-parallel ribs and/or grooves do not have to extend completely in parallel with one another in the sense that the contour lines thereof or the tangents in contact therewith do not cross at any point; rather, the expression “parallel and/or quasi-parallel ribs and/or grooves” is understood to mean in particular also such ribs and/or grooves which are adjacent to one another and at the same time have a substantially identical curve shape. Within the meaning of the present invention, the parallel and/or quasi-parallel ribs and/or grooves can be in particular irregularly meander-shaped ribs and/or grooves which are adjacent to one another and at the same time have a substantially identical curve shape.

The invention is based on the concept of producing, on the surface layer formed of thermally curable resin (synthetic resin), irregular microstructures in the form of line structures, of which the width is in the range of from 0.5 μm to 100 μm, by means of a correspondingly structured embossing tool, for example by means of one or more correspondingly structured pressure plates or pressure belts, the microstructures being derived from ripple finish textures, which are characterised by irregularly alternating regions of more ordered and more non-ordered line structures. In this case, the line structures are formed, for example, as irregularly meander-shaped ribs and/or grooves, said line structures comprising more ordered line structures in the form of substantially contour-compliant adjacent ribs and/or grooves and more non-ordered, i.e. less to not at all ordered, line structures in the form of ribs and/or grooves that extend transversely to one another.

Similarly, when implementing the invention in practice, textural images produced in a controlled manner can be used which have been or are produced from algorithms and/or fractal and/or replicated pattern sequences, and have the same characteristic textural features as ripple finish textures, i.e. a sequence of ordered and non-ordered grooves and/or ribs or structural breaks.

A considerable anti-fingerprint effect is achieved by these irregular, fine line structures having ordered or more ordered and less to not at all ordered line structures. At the same time, the fineness of the linear structures means that there is a relatively low reflectance and thus a matt surface. In this case, the reflectance (degree of gloss) of the surface layer formed according to the invention can be varied by the structural geometry and the structural size, in particular the depth of the grooves. In addition, the thermally curable resin (synthetic resin) gives the decorative surface a good wear resistance.

The component according to the invention is, for example, a furniture element, door element, wall panel, ceiling panel, floor panel or outer facade element, or is intended for the manufacture of such elements or panels. The furniture element can be in particular a tabletop, a worktop, a cupboard door, a cupboard side wall, a cabinet shelf, a drawer front, a shelf, a shelf side wall and the like.

The plate-shaped or profile-shaped support of the component is formed for example of wood material, laminate composite and/or cardboard. The laminate composite consists of a plurality of paper layers soaked in phenol resin or melamine resin, which are joined under high pressure. Such supports consisting of laminate composite are also referred to as high pressure laminates (HPL). The support of the component according to the invention formed of wood material can be a chipboard or fibreboard, in particular a HDF or MDF board. The plate-shaped or profile-shaped support of the component according to the invention can also be what is referred to as a sandwich board, which comprises a core formed of a honeycomb board or a rigid foam board.

The decorative surface layer connected to the support can have one or more layers. Said decorative surface layer comprises for example a decor paper layer, a pattern printed directly on the support and/or at least one paint layer. The pattern of the decor paper or the directly printed pattern is, for example, a wood pattern, stone pattern, tile pattern or fancy pattern. In particular, the pattern can also be a uniformly single-coloured surface pattern, such as a single-coloured, all-over paint layer or a single-coloured decorative film.

The decorative surface layer is formed of thermally curable resin, preferably melamine resin, urea resin or a mixture of such resins, the resin being arranged on or applied to at least the outside of the surface layer. However, the decorative surface layer can also have thermally curable resin over the entire layer thickness thereof, or be formed thereof. The thermally curable resin can be transparent, semi-transparent or opaque. In addition, the thermally curable resin can also be single-coloured or multi-coloured.

A preferred embodiment of the invention provides that the respective rib or groove of the surface structure has a height or depth of at most 30 μm, preferably at most 10 μm. This embodiment is advantageous from a hygiene perspective since less dirt can collect in the surface structure of the component when there is a correspondingly small height or depth of the line-shaped structural elements. For example, the ribs and/or grooves of the surface structure have a height or depth in the range of from 0.5 μm to 15 μm, preferably in the range of from 0.5 μm to 10 μm, particularly preferably in the range of from 0.5 μm to 8 μm.

The ridge length of individual ribs or the trough length of individual grooves of the surface structure is for example in the range of from 10 μm to 500 μm, preferably in the range of from 20 μm to 200 μm.

According to another preferred embodiment of the invention, the ribs of the surface structure comprise round rib ridges. As a result, the surface layer of the component according to the invention is mechanically more robust against what are referred to as “gleamers”, and can also be demoulded from the correspondingly structured embossing tool, e.g. pressure plate or pressure belt, in a simpler and more residue-free manner. In this regard, it is also advantageous if, according to another embodiment of the invention, all of the high points of the ribs are substantially the same height or all the low points (troughs) of the grooves are substantially the same depth.

The structured embossing surface of the embossing tool can be produced relatively cost-effectively by laser engraving, the grooves being burnt directly into a metal tool surface and the die surface being chrome-plated after the grooves have been burnt in. Etching the tool surface to produce the required structures is not necessary in this case.

Alternatively, the embossing surface can also be produced by laser engraving such that the grooves are burnt into a chrome-plated metal tool surface. In this case, a rough-polished and sufficiently thickly chrome-plated die surface of a suitable metal sheet or roll body can be used as the starting material. After the laser engraving process, no further processing is required for the pressure plate or press roll manufacturer, i.e. no subsequent chrome-plating step is required.

Another variant for manufacturing a suitable embossing tool in order to produce surface structures according to the invention in a thermally curable resin layer is characterised in that the embossing surface of the tool is produced by selectively burning away an etching paint applied all over a tool surface, an etching mask thus produced then being subjected to an etching process in order to produce the grooves having a desired depth. In this variant, a low-energy laser can be used to selectively burn away the etching paint. The option of using a low-energy laser has advantages in terms of cost of equipment.

The invention will be described in more detail in the following with reference to the accompanying drawings and on the basis of a plurality of embodiments. In the drawings:

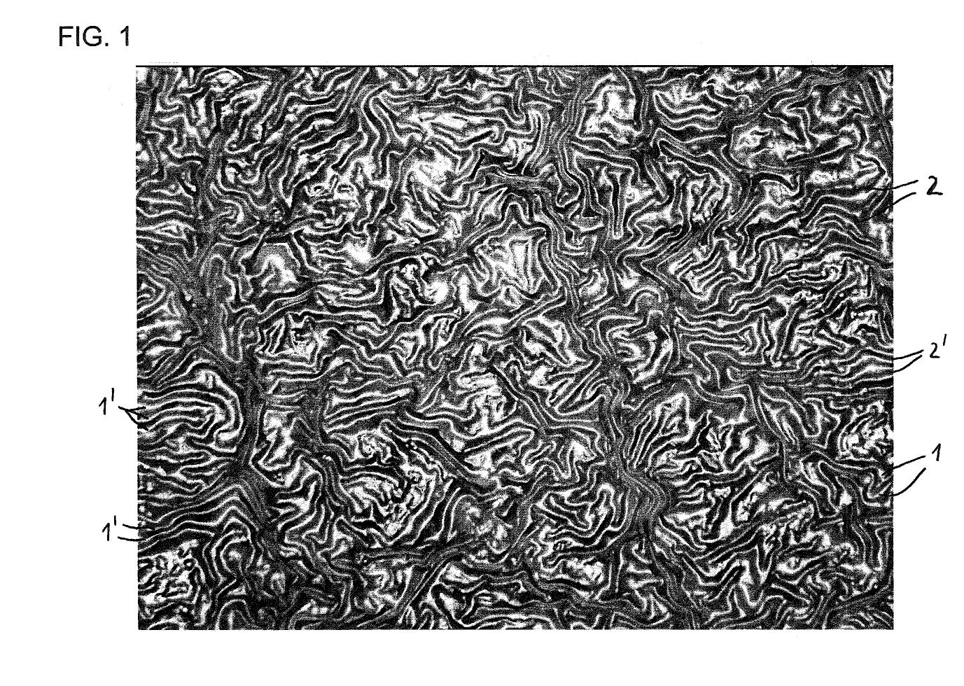

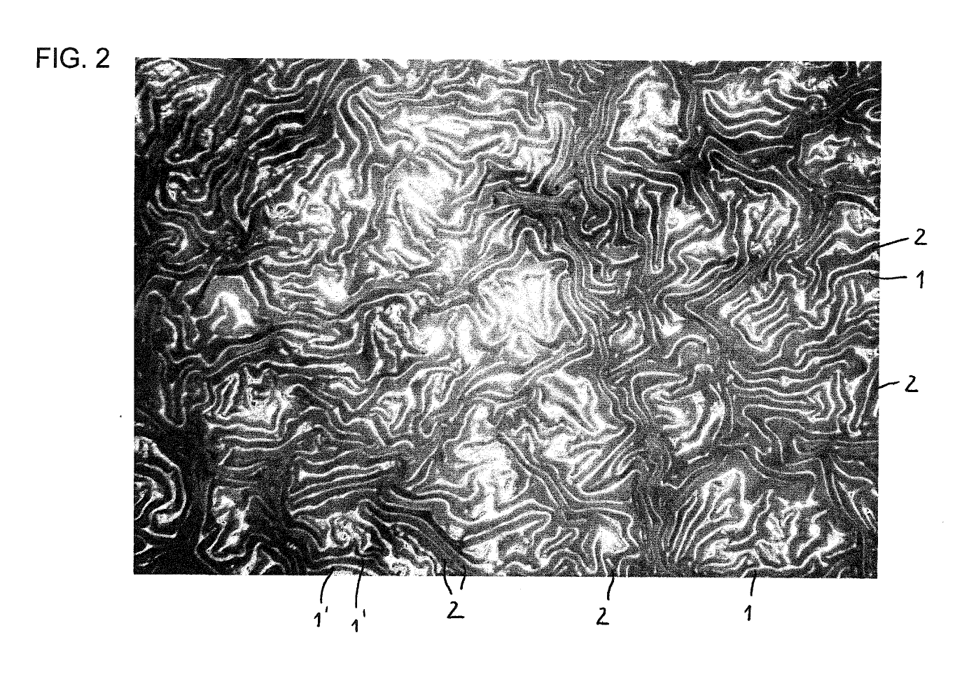

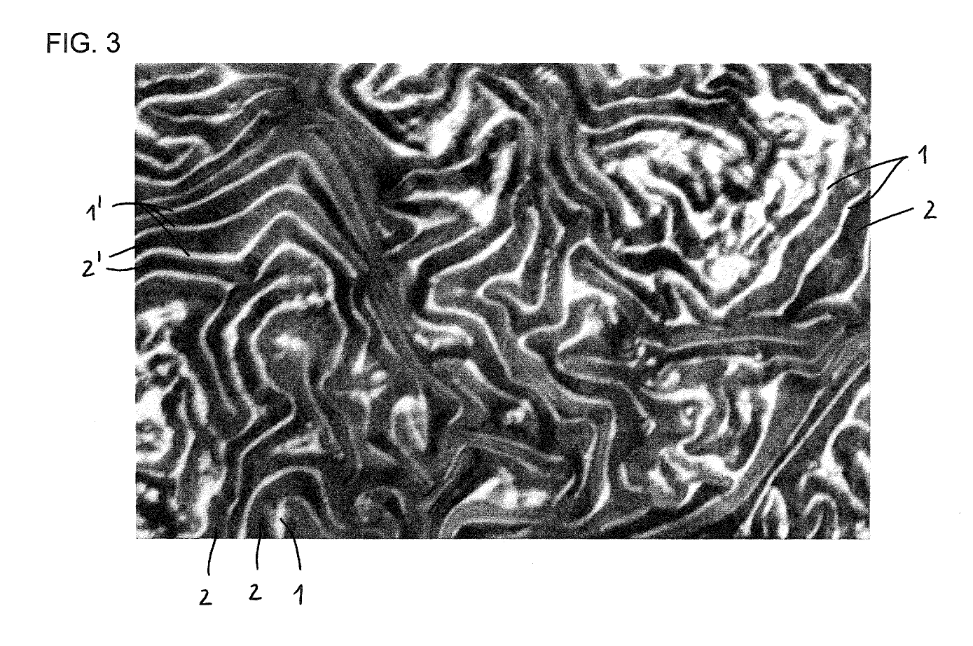

FIGS. 1 to 3 are images of portions of a surface structure of a component according to the invention, which have been taken by an atomic force microscope at different magnifications;

FIGS. 4 and 5 show two examples of structural images which have been produced using algorithms;

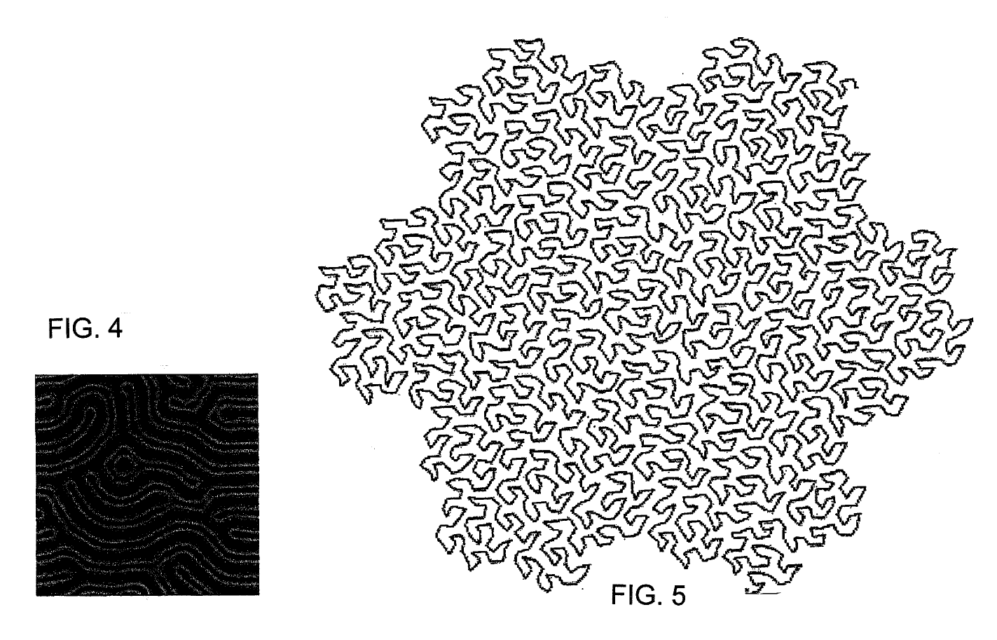

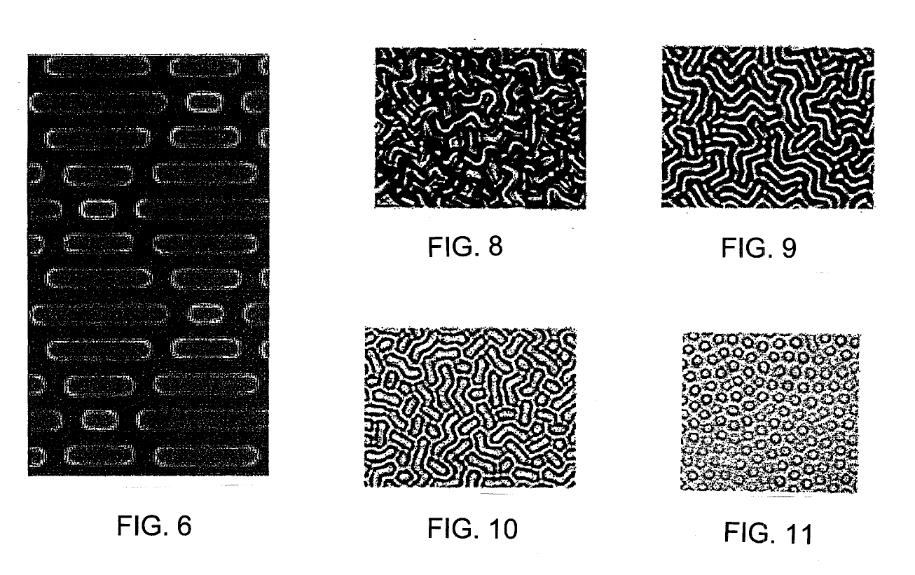

FIG. 6 is an example of a technically generated structural image derived from a ripple finish texture;

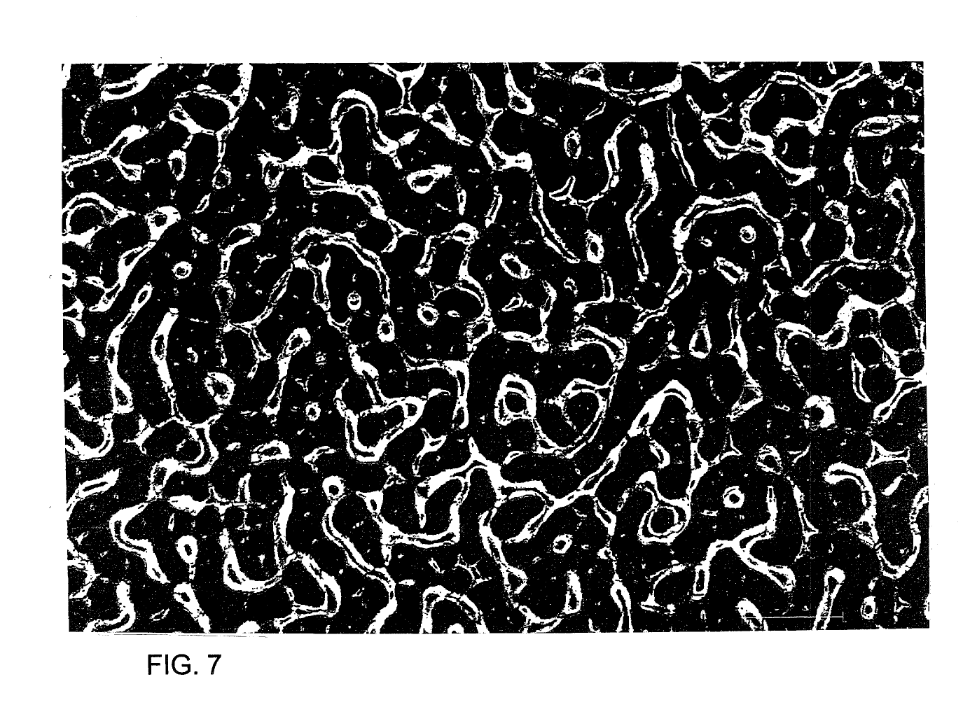

FIG. 7 is an example of a random structural image that is derived from a ripple finish texture and has been produced by means of a laser; and

FIGS. 8 to 11 are further examples of technically generated structural images which are each derived from a ripple finish texture.

Atomic force microscopy (AFM) is a surface-sensitive technique for imaging the texture and morphology or topography of the surface of a sample. In this case, the surfaces of the samples to be analysed are scanned using a measuring probe and the interaction between the probe and the sample surface is mapped. The measurement probe, also referred to as a cantilever, comprises a resilient portion which acts as the reflective surface for a laser beam. In this case, the laser beam is deflected at different angles depending on the resilient deformation of the cantilever and the reflected, deflected laser beam is detected by a photodetector. The resilient deformation of the cantilever and thus the deflection of the laser beam depend on the height profile of the sample surface. When the sample surface is scanned, each point in the xy plane is assigned a brightness value depending on the extent of the deflection of the laser beam and thus an image of the surface profile of the sample is produced on the screen of the atomic force microscope. The movement of the cantilever in the z direction (distance from the surface) is also detected.

FIGS. 1 to 3 show images at different magnifications of surface portions of a sample of a component according to the invention analysed by an atomic force microscope. The component, which is for example a furniture board or a wall panel, comprises a plate-shaped support which is coated on one or both sides with a decorative surface layer. The support and the decorative surface layer are integrally bonded together. The decorative surface layer is formed of thermally curable resin, preferably melamine resin and/or urea resin, the resin being provided on at least the top of the decorative surface layer.

A three-dimensional, irregular surface structure is embossed into the surface layer or the resin layer by means of a structured embossing tool, for example a structured pressure plate or pressure belt.

It can be seen in FIG. (images) 1 to 3 that the surface structure comprises irregularly meander-shaped ribs 1 and grooves 2, of which some extend transversely to one another and some are adjacent to one another in a substantially contour-compliant manner. The ribs and/or grooves that extend transversely to one another enclose angles of different sizes, in particular in the range of from 30° to 150°. The adjacent, contour-compliant ribs 1′ and/or grooves 2′ have a substantially identical curve shape.

The ribs 1, 1′ and grooves 2, 2′ are formed so as to be very fine, in particular very narrow. The width of the respective rib 1, 1′ or groove 2, 2′ is in the range of from 0.5 μm to 100 μm, preferably in the range of from 2 μm to 50 μm. The height or depth of the ribs 1, 1′ or grooves 2, 2′ is in the range of from 0.5 μm to 15 μm, preferably in the range of from 0.5 μm to 10 μm, particularly preferably in the range of from 0.5 μm to 8 μm. The ridge length of individual meander-shaped ribs 1, 1′ or the trough length of individual meander-shaped grooves 2, 2′ of the surface structure is for example in the range of from 10 μm to 500 μm, in particular in the range of from 20 μm to 200 μm.

The different structural regions (structural units) of the surface result in different indices of refraction or reflectances and thus the effect of the at least partial non-visibility of fingerprints. The variation in the fineness of these surface structures determines both the degree of matting and the anti-fingerprint properties in connection with the selected type of structuring. The finer the three-dimensional surface structure in the form of ribs and/or grooves in the above-mentioned regions, the smaller the degree of gloss of the surface. The rougher the surface structure in the above-mentioned regions, the better the anti-fingerprint properties. The rib ridges of the ribs 1, 1′ are well rounded when viewed in cross section. The ribs 1, 1′ comprise a substantially parabolic or substantially semi-circular cross-sectional contour, for example. The same also preferably applies to the cross-sectional contour of the grooves 2, 2′.

In order to manufacture components having a decorative surface, of which the decorative surface has a good wear resistance and largely prevents objectionable fingerprints, the invention thus provides that the structural characteristics of a ripple finish surface, i.e. a sequence of more ordered and more non-ordered structural elements in the micrometre range, are embossed or pressed into a surface layer made of thermally curable resin. For this purpose, textural images produced in a technically controlled manner can be preferably also used by the textural image being incorporated into the surface of an embossing tool, for example a pressure plate, or being used as a template for manufacturing the die surface (embossing surface). In this case, as textural images produced in a controlled manner, in particular such textural images can be used which are produced by an algorithm and/or from fractal and/or replicated pattern sequences. In this regard, a number of examples are shown in FIGS. 4 to 11.

FIG. 4 shows a structural image generated by means of one or more differential equations, while FIG. 5 illustrates a fractured structural formation based on a vector graphic. FIG. 6 shows a technically simple alternation of ordered and non-ordered textural elements or structures, the non-ordered textural elements (structures) defining a textural break (interruption). FIG. 7 shows an image of a random pattern produced by a laser beam and having more ordered and more non-ordered structural elements in the form of grooves or ribs.

FIGS. 8 to 11 show patterns derived from ripple finish textures which have similar characteristics to ripple finish textures, specifically a sequence of (relatively) ordered or more ordered and non-ordered or less ordered structural elements, in turn FIG. 8 showing a non-ordered texture, FIG. 9 showing a lamellar or strip-like structure having a plurality of strip-like structural elements, FIG. 10 showing a “peanut” structure having a plurality of peanut-shaped structural elements, and FIG. 11 showing a structure having a plurality of hexagonal structural elements.

An embossing tool suitable for producing one of the structural images shown in FIGS. 1 to 11 or a corresponding surface structure, for example a textured pressure plate or a textured press roll, can be manufactured by laser machining (laser engraving) the die surface (embossing surface).

One embodiment of the laser engraving of a metal tool surface for producing surface structures according to the invention in surface layers made of thermally curable resin, in particular melamine resin, is characterised in that the grooves or structures required for this purpose are burnt directly into the metal tool surface, which is preferably made of steel, and the tool surface is chrome-plated after the grooves or structures have been burnt in. Etching the die surface in order to produce the grooves (structures) is not required in this case. The pressure plates or press rolls textured by the direct laser engraving can be inserted immediately after a final chrome-plating step. In this case, no matt chromium needs to be used in order to reduce the degree of gloss of the embossing surfaces of the press surfaces or press rolls.

Another option for manufacturing pressure plates or press rolls having the required microstructures for producing surface structures according to the invention in thermally curable resin layers consists in producing the embossing surface by laser engraving, the grooves being burnt into a chrome-plated metal tool surface. In this case, a subsequent chrome-plating step would not be required. In this case, a rough-polished and sufficiently thickly chrome-plated metal sheet, preferably sheet steel, can be used as the starting material, in which metal sheet the required microstructures can be burnt by means of laser engraving.

Another variant for manufacturing pressure plates or press rolls having the required microstructures for producing surface structures according to the invention in thermally curable resin layers consists in producing said microstructures by selectively burning away, by means of at least one low-energy laser, an etching paint applied all over the sheet surface or roll sleeve surface. The etching mask thus produced is then subjected to an etching process in order to produce the required grooves having the desired depth in the pressure plate or in the roll sleeve surface.

The implementation of the present invention is not restricted to the exemplary embodiment shown in the drawings, but rather numerous variants are conceivable which make use of the invention outlined in the accompanying claims even if the design is different from the example.

1. A component having a plate-shaped or profile-shaped support and a decorative surface layer connected to the support, whereby the support comprises at least one of a wood material, a high pressure laminate (HPL) and a cardboard and the surface layer comprises a thermally curable resin and a three-dimensional surface structure that is produced by embossing and is irregular, wherein the surface structure comprises regions that are alternately ordered and non-ordered and that are formed by a ribbed or a grooved texture, the ordered regions having parallel or quasi-parallel ribs and parallel or quasi-parallel grooves being interrupted by the non-ordered regions or by structural breaks, and wherein a width of the respective rib or groove being between 0.5 μm to 100 μm.

2. The component according to claim 1, wherein the width of the respective rib or groove is in the range of from 2 μm to 50 μm.

3. The component according to claim 1, wherein the respective rib has a maximum height of 15 μm.

4. The component according to claim 1, wherein the respective groove has a maximum depth of 15 μm.

5. The component according to claim 1, wherein the ribs comprise round rib ridges.

6. The component according to claim 1, wherein the surface layer is formed of melamine resin, urea resin or a mixture of such resins.

7. A method for manufacturing a component having a plate-shaped or profile-shaped support, whereby the support comprises at least one of a wood material, a high pressure laminate (HPL) and a cardboard, the method comprising:
coating the support with a decorative surface layer, the surface layer comprising a thermally curable resin and a three-dimensional, irregular surface structure; and
embossing into the surface layer, wherein an embossing tool is used to emboss the surface layer, of which the embossing tool the embossing surface comprises regions that are alternately ordered and non-ordered and that are formed by a ribbed or grooved structure, the ordered regions having parallel or quasi-parallel ribs and parallel or quasi-parallel grooves being interrupted by the non-ordered regions or by structural breaks, and wherein a width of the respective rib or groove being between 0.5 μm to 100 μm.

8. The method according to claim 7, wherein the width of the respective rib or groove is between 2 μm to 50 μm.

9. the method according to claim 7, wherein the respective rib has a maximum height of 15 μm.

10. The method according to claim 7, wherein the respective groove has a maximum depth of 15 μm.

11. The method according to claim 7, wherein the ribs comprise round rib ridges.

12. The method according to claim 7, wherein the surface layer is formed of melamine resin, urea resin or a mixture of such resins.

13. The method according to claim 7, wherein the embossing surface is produced by laser engraving, the grooves being burnt into a metal tool surface and the tool surface being chrome-plated after the grooves have been burnt in.

14. The method according to claim 7, wherein the embossing surface is produced by laser engraving, the grooves being burnt into a chrome-plated metal tool surface.

15. The method according to claim 7, wherein the embossing surface is produced by selectively burning away an etching paint applied all over a tool surface, an etching mask thus produced then being subjected to an etching process in order to produce the grooves having a desired depth.

16. The component according to claim 3, wherein the respective rib has a maximum height of 10 μm.

17. The component according to claim 4, wherein the respective groove has a maximum depth of 10 μm.

18. A method according to claim 9, wherein the respective rib has a maximum height of 10 μm.

19. A method according to claim 10, wherein the respective groove has a maximum depth of 10 μm.
